(19) United States
(12) Patent Application Publication
(10) Pub. No.: US 2016/0077407 A1
(43) Pub. Date: Mar. 17, 2016

(54) ADAPTER FOR JOINING FLASH UNIT AND LIGHT DIFFUSER, AND ASSEMBLY OF LIGHT DISFFUSER, FLASH UNIT, AND ADAPTER

(71) Applicant: Kevin Kubota, Bend, OR (US)

(72) Inventor: Kevin Kubota, Bend, OR (US)

(21) Appl. No.: 14/855,773

(22) Filed: Sep. 16, 2015

Related U.S. Application Data
(60) Provisional application No. 62/051,734, filed on Sep. 17, 2014.

(51) Int. Cl. G03B 15/06; F21V 1/06

(52) U.S. Cl. CPC G03B 15/06; F21V 1/06

(57) ABSTRACT

There is provided an adapter for joining a flash unit and a light diffuser. The adapter includes a holder including anchor points and rods including first ends and second ends. The first ends are configured to be attached to the anchor points, and the second ends including couplings are configured to be attached to a light diffuser. A mounting point may be attached to the holder, and the mounting point may retain a flash unit in a position to emit light toward the light diffuser. There is also provided an assembly including a light diffuser; a flash unit; and the adapter.

This application is a non-provisional application of provisional application No. 62/051,734, filed in the U.S. Patent and Trademark Office on Sep. 17, 2014, the content of which is incorporated herein by reference in its entirety.

### FIELD

This disclosure relates generally to an adapter for joining a flash unit and a light diffuser, and an assembly of a light diffuser, a flash unit, and an adapter.

### BACKGROUND

Collapsible diffuser discs are versatile lighting tools used by photographers in the field and studio. The discs are commonly referred to as 3-in-1 or 5-in-1 pop-up discs because they often include reflective covers for the diffusion material offering multiple light-modifying options. The most commonly used collapsible diffuser discs have a circumference of 12″, 22″, 32″, or 42″.

When a flash unit is held at a distance of about three feet behind the diffusion disc, and the light is directed through the diffusion, it produces lighting quality similar to industry standard light boxes, which are more expensive and time consuming to set up.

Combining the use of a collapsible diffuser disc with a mounting for a portable flash unit has so far been limited to having an individual person other than the photographer physically position and hold the diffuser disc in one hand and hold the flash unit in the other. Flash units can be placed on light stands, and the diffuser can be held with a stand.

Holding both the collapsible diffuser and the portable flash unit by hand for the desired lighting effect is inconvenient and provides inconsistent results as the distance between the diffuser and the flash unit is constantly changing and irregular. To achieve the desired lighting effect, the flash unit and diffuser should be aligned and maintained at a constant distance from each other when illuminating a subject for a single image or video.

Providing separate stands for the portable flash unit and the diffusion disc creates problems that the equipment is not easily portable, quick to reposition, or convenient to set up. Furthermore, the use of separate stands requires additional investment in equipment.

### SUMMARY

A first aspect is directed to an adapter for joining a flash unit and a light diffuser, the adapter comprising:

a handle;

a holder attached to the handle, the holder including anchor points;

a mounting point attached to the handle, the mounting point being configured to retain a flash unit; and

rods including first ends and second ends, the first ends being configured to be attached to the anchor points, and the second ends including couplings configured to be attached to a light diffuser, wherein adapter is configured to position the flash unit to emit light toward the light diffuser.

In an embodiment, the adapter further comprises a bracket attached to the handle, wherein the mounting point is disposed on the bracket.

In an embodiment, the holder further includes a frame including an opening, the anchor points are spaced apart on the frame, and the frame is oriented to allow the light emitted from the flash unit to pass through the opening and toward the light diffuser.

In an embodiment, the frame includes a ring shape.

In an embodiment, the rods are flexible.

In an embodiment, each of the rods includes cylindrical sections, and adjacent ends of the cylindrical sections are configured to be detachably engaged together at a joint.

In an embodiment, couplings include hooks configured to grasp the light diffuser.

In an embodiment, the light diffuser is planar and the hooks grasp a peripheral edge of the light diffuser.

A second aspect is directed to an adapter for joining a flash unit and a light diffuser, the adapter comprising:

a holder including anchor points;

rods including first ends and second ends, the first ends being configured to be attached to the anchor points, and the second ends including couplings configured to be attached to a light diffuser;

a mounting point attached to the holder, wherein the mounting point is configured to retain a flash unit in a position to emit light toward the light diffuser.

In an embodiment, the holder further includes a frame including an opening, the anchor points are spaced apart on the frame, and the frame is oriented to allow the light emitted from the flash unit to pass through the opening and toward the light diffuser.

In an embodiment, the frame includes a ring shape.

In an embodiment, the rods are flexible.

In an embodiment, each of the rods includes cylindrical sections, and adjacent ends of the cylindrical sections are configured to be detachably engaged together at a joint.

In an embodiment, the couplings include hooks configured to grasp the light diffuser.

In an embodiment, the light diffuser is planar and the hooks grasp a peripheral edge of the light diffuser.

A third aspect is directed to an assembly comprising:
a light diffuser;
a flash unit; and
an adapter comprising:
   a holder including anchor points,
   rods including first ends and second ends, the first ends being attached to the anchor points and the second ends including couplings attached to the light diffuser,
   a mounting point retaining the flash unit,
wherein the flash unit is positioned to emit light toward the light diffuser.

In an embodiment, the holder further includes a frame including an opening, the anchor points are spaced apart on the frame, and the frame is oriented to allow the light emitted from the flash unit to pass through the opening and toward the light diffuser.

In an embodiment, the frame includes a ring shape.

In an embodiment, the couplings include hooks grasping the light diffuser.

In an embodiment, the light diffuser is planar and the hooks grasp a peripheral edge of the light diffuser.

### BRIEF DESCRIPTION OF THE DRAWINGS

FIG. 1 is a front side elevational view of an embodiment of a handle and a holder of an adapter.

FIG. 2 is a right side elevational view of an embodiment of a handle and a holder of an adapter.

FIG. 3 is a left side elevational view of an embodiment of a handle and a holder of an adapter.

FIG. 4 is a top plan view of an embodiment of a handle and a holder of an adapter.

FIG. 5 is a bottom plan view of an embodiment of a handle and a holder of an adapter.

FIG. 6 is a front side perspective view of an embodiment of a handle and a holder of an adapter.

FIG. 7 is a rear side perspective view of an embodiment of a handle and a holder of an adapter.

FIG. 8 is a perspective view of an embodiment of an adapter attached to a light diffuser.

FIG. 9 is a perspective view of a portion of the adapter illustrated in FIG. 8.

FIG. 10 is a perspective view of an embodiment of an assembly including an adapter, a light diffuser, and a flash unit.

FIG. 11 is a left side elevational view of the assembly illustrated in FIG. 10.

FIG. 12 is a perspective view of a portion of the assembly illustrated in FIG. 10.

FIG. 13 is a side elevational view of an embodiment of a second end of a rod including a coupling.

FIG. 14 is a perspective view of the second end of the rod illustrated in FIG. 13.

FIG. 15 is a perspective view of an embodiment of a second end of a rod including a coupling attached to a peripheral edge of a light diffuser.

FIGS. 16-18 are a cross-sectional views of an embodiment of a holder of an adapter.

### DETAILED DESCRIPTION

An adapter attaches a small portable photographic flash unit (or flash units) to a light diffuser, e.g., diffusion disc, while holding the flash unit(s) and light diffuser at a consistent and optimum distance apart, in order to achieve photographic lighting similar to bulkier and expensive photographic soft boxes. An assembly including the adapter, a flash unit, and a light diffuser may be used to illuminate still images or video. Using the adapter, the combination of multiple existing accessories (i.e. the flash units and light diffusers) may be easily assembled as needed in the field or in a studio.

The adapter may conveniently hold a portable flash unit and a collapsible light diffuser, e.g., a 3-in-1 or 5-in-1 disc, together. When used together in this manner, the flash unit and diffuser produce a soft and diffused photographic lighting effect similar to that achieved with more expensive and complicated photographic soft boxes. The adapter simplifies the combination of the portable flash unit and collapsible diffuser in a convenient and consistent manner, improving upon the current practice of holding the devices together by hand.

Embodiments of the adapter are directed to holding a photographer's flash unit(s) and his/her existing diffuser disc (also known as a pop-up diffusion disc, or the 3-in-1 or 5-in-1 disc), in position, while holding the flash unit(s) and diffuser disc at a distance and angle relative to each other so as to be conducive to achieving a desired lighting effect, similar to that of a soft box. The adapter can easily be assembled in the field or in the studio, and when disassembled, the pieces can be stored in a standard-sized camera bag pocket. The adapter allows converting the user's existing pop-up disc to an improvised soft box, utilizing the discs for multiple purposes.

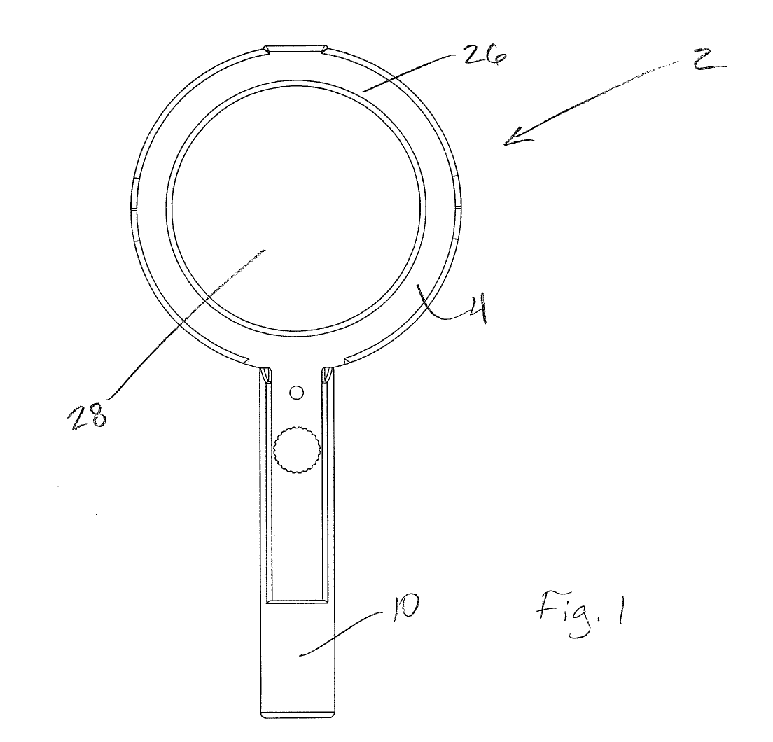

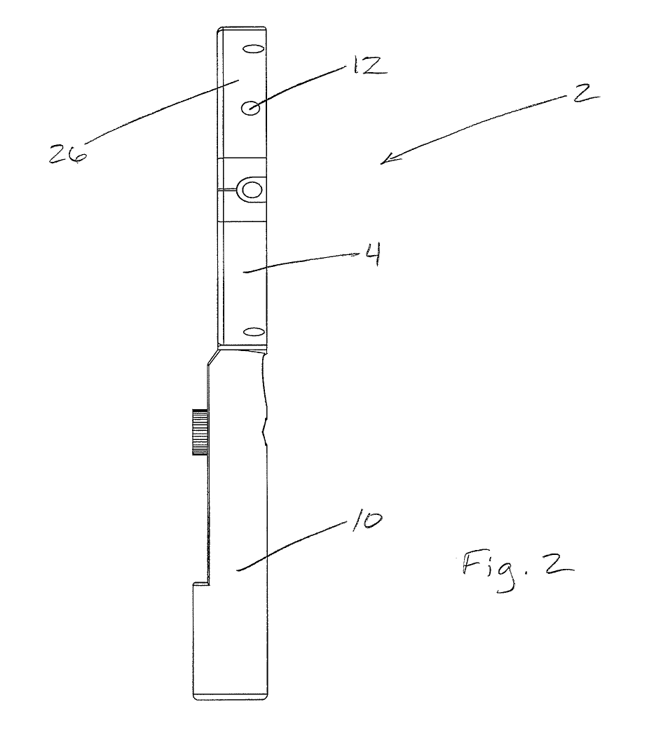

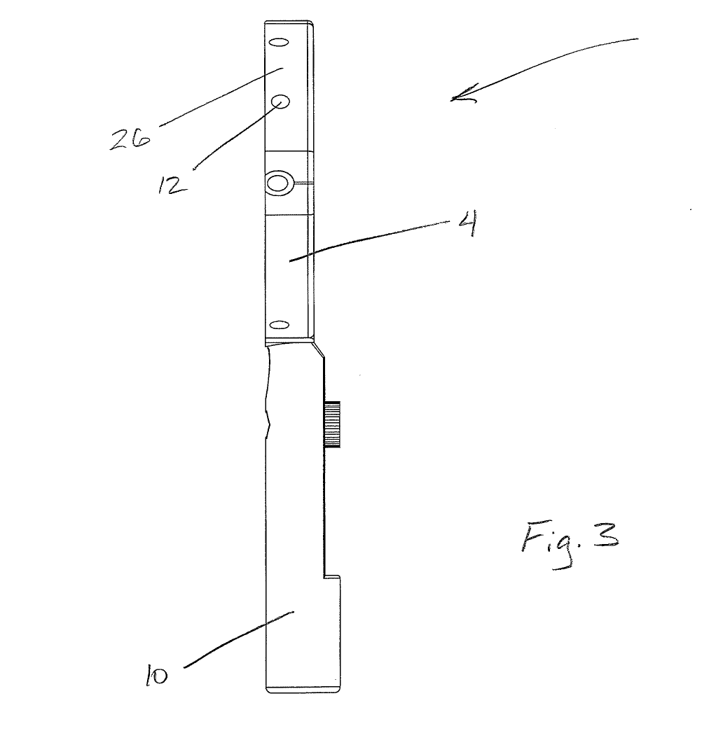

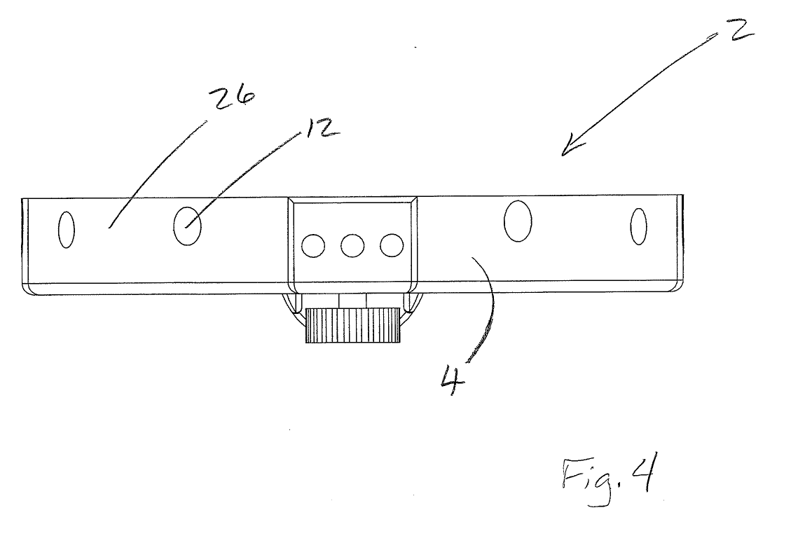

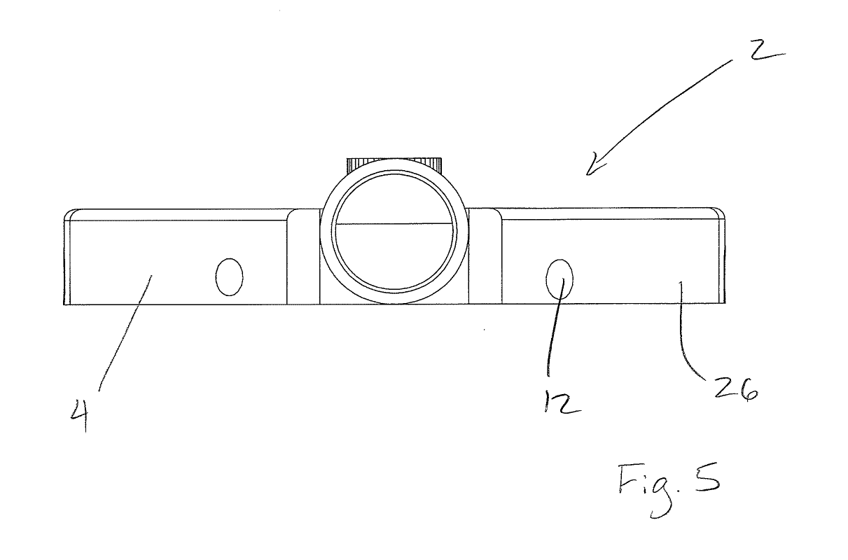

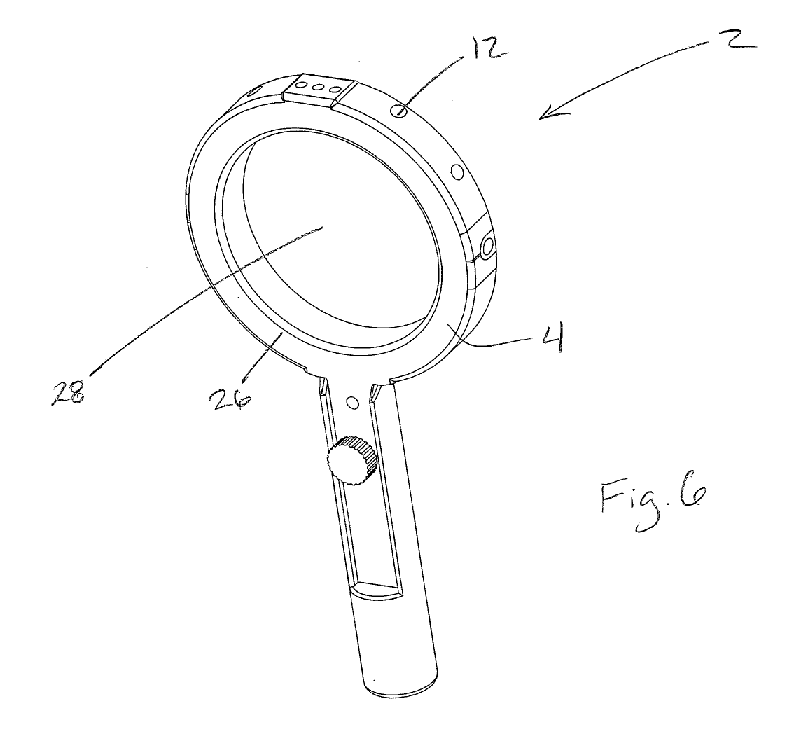

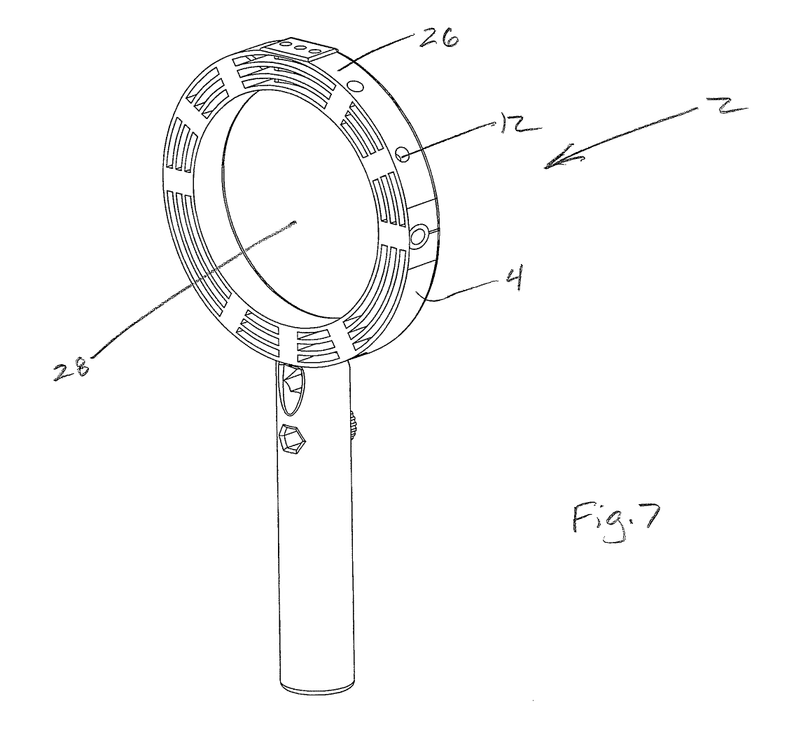

FIGS. 1-7 illustrate an embodiment of a holder 4 and a handle 10 of an adapter 2 for joining a flash unit and a light diffuser. A base of the handle may include a screw hole or fitting for attachment of the handle to a structure such as a stand, or a tripod, a monopod, etc. The holder includes a ring-shaped frame 26 including an opening 28. A flash unit may be attached to the adapter and positioned to emit light through the circular opening 28 in the middle of the frame 26 of the holder 4. Anchor points 12 are provided in the frame 26 of the holder 4. The anchor points 12 are spaced apart on the frame.

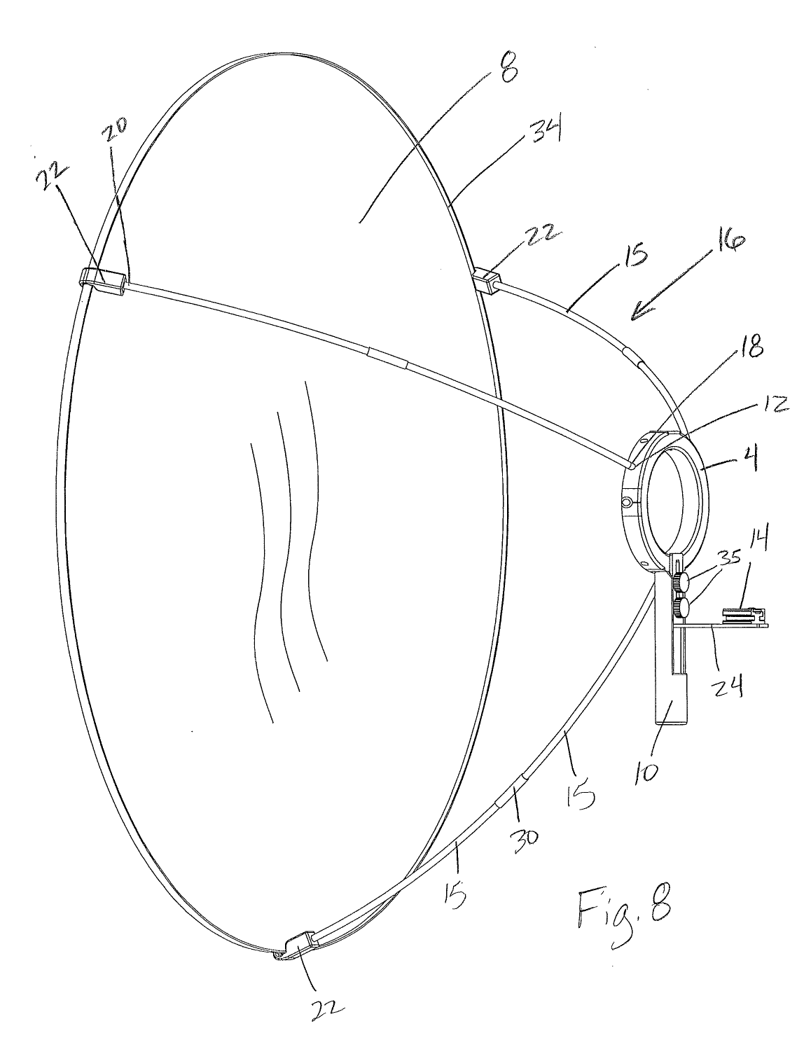

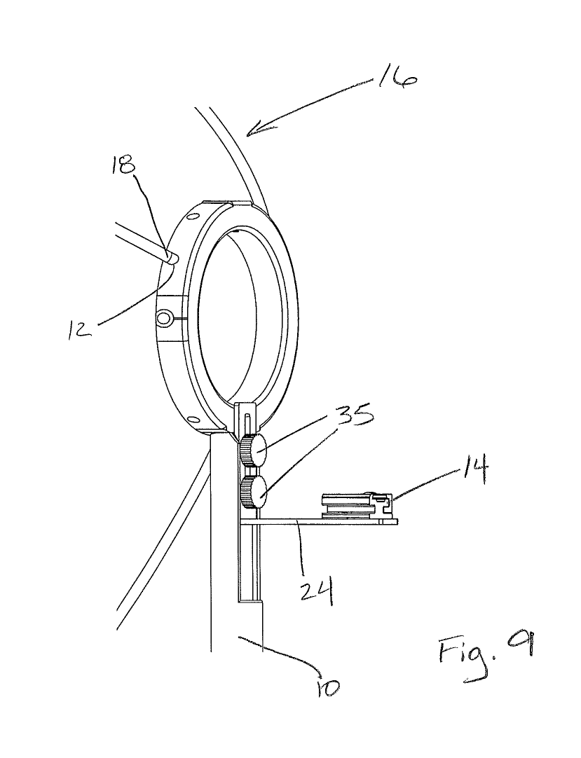

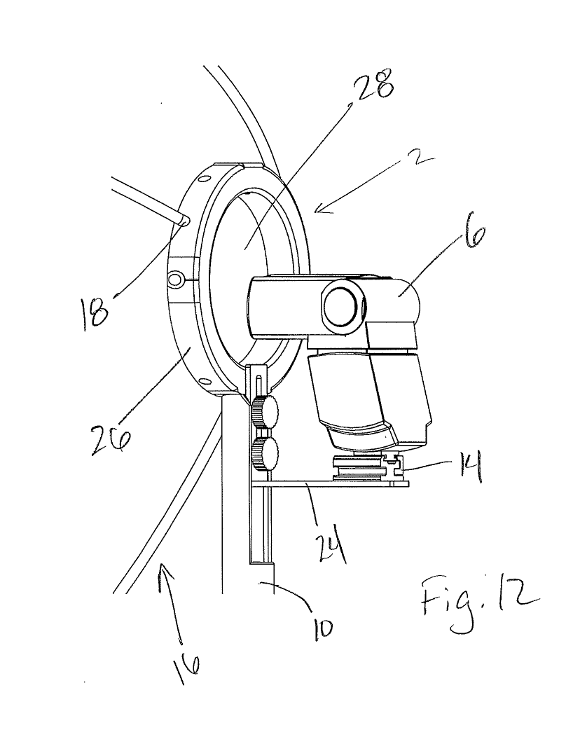

FIGS. 8-12 illustrate rods 16 of the adapter 2 attached to the holder 4 that is illustrated in FIGS. 1-7. In this embodiment, the rods 16 are flexible and include first ends 18 and second ends 20. The first ends 18 of the rods 16 are attached to the anchor points 12 of the holder 4. In this embodiment, each of the rods 16 includes cylindrical sections 15, and adjacent ends of the cylindrical sections are detachably engaged together at a joint 30. The cylindrical sections 15 may be separated, in order to collapse the rods for easy storage.

The rods of the adapter may be collapsible or non-collapsible. The rods may be rigid or flexible. Another embodiment of a collapsible rod includes a telescoping rod that collapses in an axial direction without separation of sections of the rod.

In the embodiment that is illustrated in FIGS. 1-12, the anchor points 12 are holes formed in the frame 26 of the holder 4. A first end 18 of a rod 16 fits within the hole of the anchor point 12 with a friction fit.

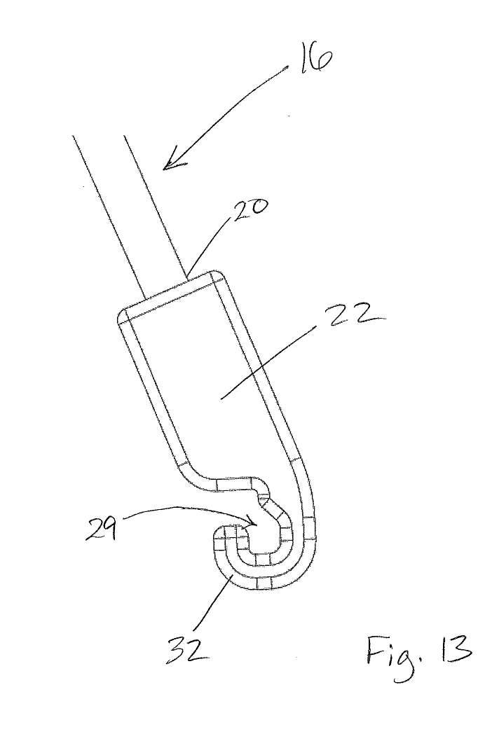

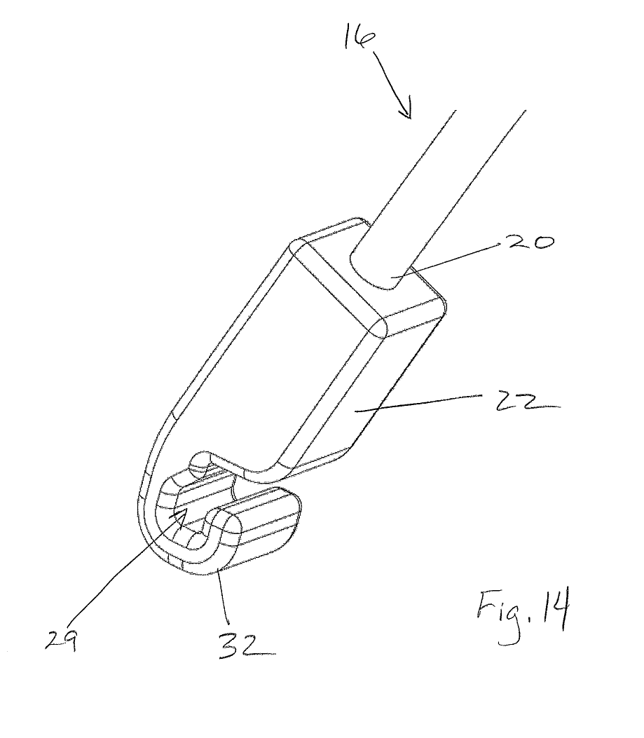

FIGS. 8, 10, and 11 illustrate the embodiment of the holder 4 illustrated in FIGS. 1-7 with first ends 18 of three flexible rods 16 inserted into anchor points 12 and second ends 20 of the rods 16 coupled or clipped to the peripheral edge of the light diffuser 8. In this embodiment, the three rods 16 are placed equidistantly around the light diffuser 8. The second ends 20 of the rods 16 include couplings 22, and the couplings are attached to a light diffuser 8. As illustrated in FIGS. 13 and 14, the coupling 22 includes a hook 32. The hook 32 is configured to grasp the light diffuser. In this embodiment, the coupling includes a hole in the square-shaped bottom, and the second end 20 of a rod 16 is inserted into the hole in the coupling.

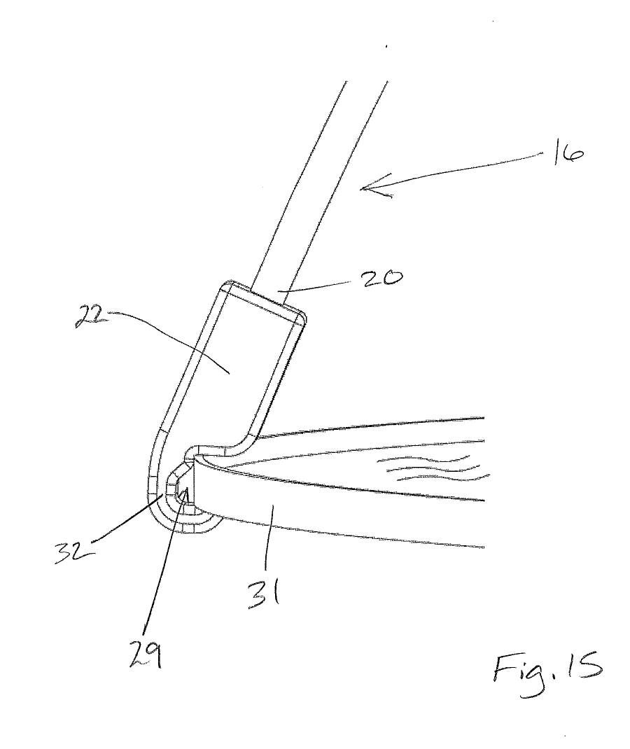

FIGS. 8, 10, and 11 illustrate the hooks 32 grasping a peripheral edge 34 of a planar light diffuser 8. In this embodiment, a hoop 31 is integrated into the peripheral edge 34 of the light diffuser 8. FIGS. 13-15 illustrate an embodiment of the hook 32 including a gap 29 having dimensions that fit over and grasp the hoop 31. In this embodiment, the first end of a rod is attached to the holder 4, the hook 32 grasps the hoop 31 of the peripheral edge 34 of the light diffuser 8, and the rod 16 flexes. The flexing of the rod 16 creates tension that maintains a connection between the gap 29 of the hook 32 and the hoop 31. The tension also maintains a connection between the first end of the rod the anchor point. FIG. 15 illustrates a gap 29 of the hook 32 engaged with the hoop 31 that is integrated in the peripheral edge of the light diffuser.

In an embodiment, the anchor points are holes including internal threading, and the first ends of the rods include external threading. An externally threaded first end of a rod may be screwed into engagement with internal threading of one of the holes.

In an embodiment the anchor points include slotted openings, and the first ends of the rods include T-shaped fasteners that are shaped to be inserted into the slotted opening and twisted into locked engagement with the slotted opening.

In an embodiment, the second ends of the rods include tips that fit within and engage with holes formed in the light diffuser. The first ends of the rods are connected with the anchor points on the holder. When the rods are flexed, tension is created. The tension maintains the engagement between the tips of the second ends of the rods and the holes formed in the light diffuser, and the tension maintains engagement between the first ends of the rods connected to the anchor points on the holder.

In an embodiment, the connection between the second ends of the rods and the light diffuser includes hook and loop connectors, such as Velcro®. For example, tips of the second ends of the rods include the loop component of the hook and loop connectors and parts of the light diffuser include hook component of the hook and loop connectors. The loop component on the second ends of the rods engages with the hook component formed on the light diffuser. In this embodiment, the first ends of the rods are externally threaded and the anchor points on the holder are internally threaded. In this embodiment, the rods need not be flexible, since the connection between the light diffuser and the second ends of the rods is maintained by the hook and loop connectors and the connection between the first ends of the rods and the anchor points are maintained by the threaded engagement between the first ends of the rods and the anchor points.

Another embodiment of the structure of the connection between the second ends of the rods and the light diffuser includes snap fasteners that attach the second ends of the rods to the light diffuser.

The rods may be flexible or rigid depending on the structure of the connection between the first ends of the rods and the holder, the structure of the connection between the second ends of the rods and the light diffuser, and whether such connections require tension to be applied between the adapter and the light diffuser in order to maintain a connection between the adapter and the light diffuser.

The connection between the second ends of the rods and the light diffuser may be formed on a peripheral edge of the light diffuser or within the field of the diffusive material spanning between the peripheral edges of the light diffuser. The couplings of the second ends of the rods may attach to the light diffuser within the field of the diffusive material or at a peripheral edge of the light diffuser.

As illustrated in FIGS. 8-12, the adapter further includes an L-shaped bracket 24 attached to the handle 10. A mounting point 14 is attached to the bracket. In this embodiment, the mounting point is a shoe mount that includes a receptacle for retaining a matching foot on a flash unit. The mounting point 14 is attached to the handle 10 by the bracket 24. In this embodiment, the bracket is attached to the handle by two bolts 35.

In an embodiment, the handle of the adapter includes an integrated mounting point, e.g., shoe mount, for retaining a matching foot of a flash unit, without requiring a separate bracket for retaining the mounting point. In this embodiment, the flash unit is retained by the adapter so that the flash bulb of the flash unit emits light toward the light diffuser.

In an embodiment, an adapter may join a flash unit and a light diffuser, and a handle is omitted. A user may directly grasp the holder, or the holder may be attached to a tri-pod, a monopod, a stand, etc. In this embodiment, the holder includes a ring-shaped frame including an opening, and anchor points formed in and spaced apart on the frame. The adapter in this embodiment also includes rods including first ends and second ends. The rods are flexible, and each of the rods includes cylindrical sections. Adjacent ends of the cylindrical sections of the rods are configured to be detachably engaged together at a joint. The couplings formed on the second ends of the rods include hooks that grasp a peripheral edge of the light diffuser. The first ends of the rods are attached to the anchor points in the frame. A mounting point is attached to the holder, and a flash unit may be attached to the mounting point so as to allow light emitted from a flash bulb of the flash unit to pass through the opening in the frame and toward the light diffuser.

In an embodiment, an adapter includes a holder with a frame having a rectangular shape with rounded corners. A flash unit may be positioned to emit light through a rectangular shaped opening in the middle of the holder. Anchor points are provided on the sides of the rectangular frame. In this embodiment, the anchor points are holes formed at angles in the frame. The purpose of these holes is for inserting the first ends of the rods. The second ends of the rods may be clipped, hooked, or otherwise attached to the light diffuser. Additional holes are provided in the frame for attaching a bracket that may retain a flash unit. A handle may be attached to the rectangular frame so that the handle may be held by hand or mounted to a tripod, a monopod, a stand, etc. The holder provides a mounting point for the portable flash and has three collapsible tent-pole-like rods that clip to the edges of the light diffuser and hold it at the optimum distance for creating a soft-box-like lighting effect.

In an embodiment, an adapter includes a holder. In this embodiment, the holder includes a block including anchor points, e.g., holes, formed therein. The block may be formed in the shape of a sphere, a cube, a rectangular cuboid, etc. First ends of the rods attach to the anchor points formed in the block and the rods radiate outward from the block in a conical or pyramidal orientation. Second ends of the rods include couplings that attach to a light diffuser. A mounting point is also formed on the holder. A flash unit may be attached to the mounting point so that light emitted by the flash bulb of the flash unit passes through the light diffuser.

In an embodiment, an adapter includes a holder. In this embodiment, the holder includes arms extending therefrom. The arms include anchor points, e.g., holes, formed therein. First ends of the rods attach to the anchor points and radiate outward from the arms in a conical or pyramidal orientation. Second ends of the rods include couplings that attach to a light diffuser. A mounting point is also formed on the holder. A flash unit may be attached to the mounting point so that light emitted by the flash bulb of the flash unit passes through the light diffuser.

In the embodiments disclosed herein, the adapter may include one, two, three, four, or more rods attached between a holder and a light diffuser.

Any type of light diffuser, e.g. circular, oval, disc-shaped, polygonal, rectangular may be attached to the adapter. The light diffuser may be planar or semi-planar. The light diffuser may form a dome shape. In addition, the light diffuser may be collapsible and include hoop of material in a peripheral edge thereof. In the collapsible light diffuser, the hoop exerts a spring force that maintains the diffuser in a deployed and open configuration. The collapsible light diffuser may be collapsed by folding the hoop and overcoming the spring force.

In addition, a reflector, e.g., as part of a 3-in-one or 5-in-one disc, may also be attached to the adapter via the rods.

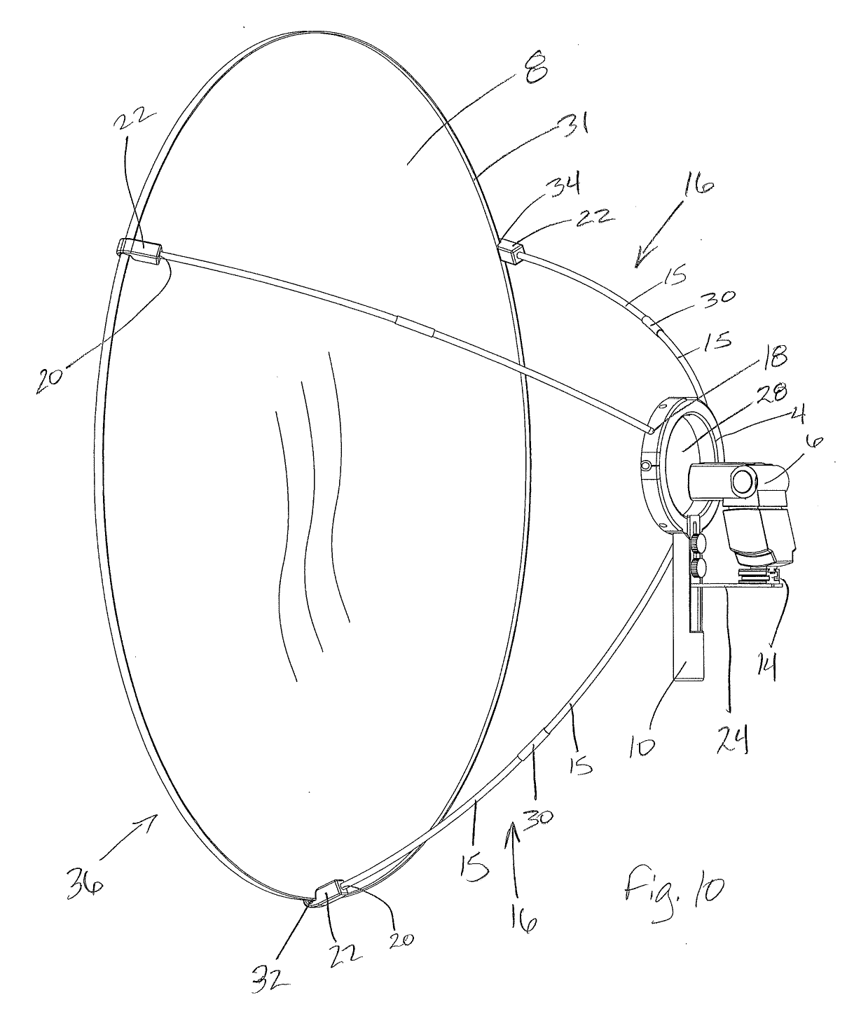

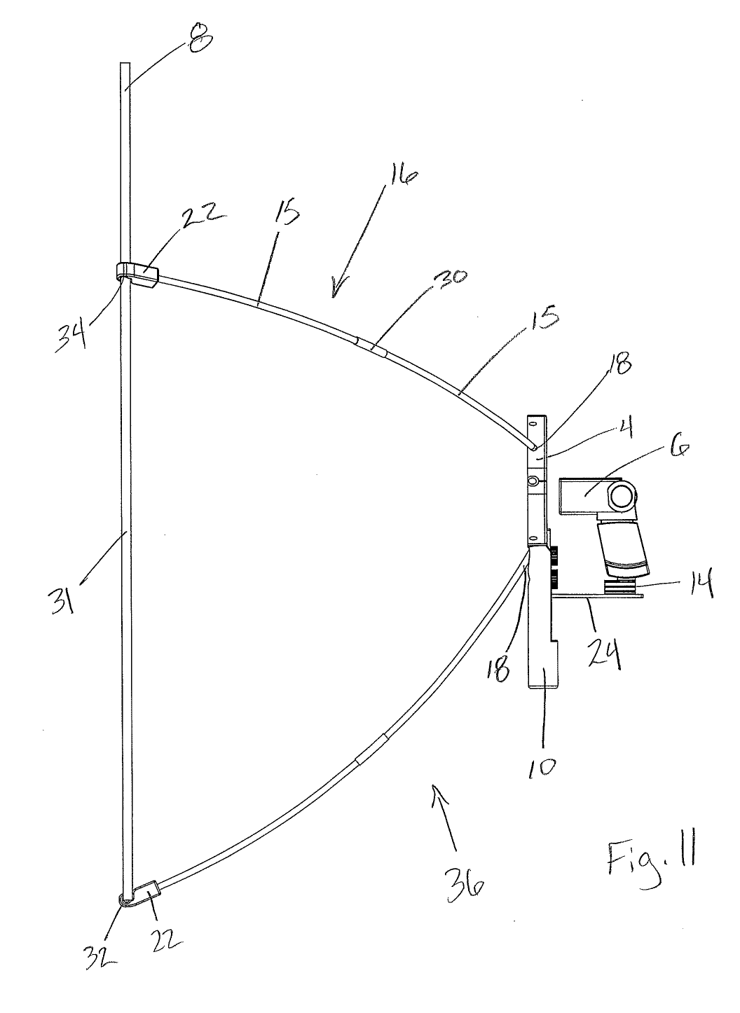

FIGS. 10 and 11 illustrate an embodiment of an assembly 36 including a light diffuser 8, a flash unit 6, and an adapter 2. As illustrated in the embodiment illustrated in FIGS. 10 and 11, the adapter positions the flash unit 6 to emit light toward the light diffuser 8. The adapter 2 includes a holder 4 including anchor points 12. The holder further includes a ring-shaped frame 26 including an opening 28. The anchor points 12 are spaced apart on the frame 26, and the frame is oriented to allow the light emitted from the flash unit to pass through the opening 28 and toward the light diffuser 8. The adapter further includes rods 16, which include first ends 18 and second ends 20. The first ends 18 are attached to the anchor points 12, and the second ends 20 include couplings 22 attached to the light diffuser 8. The couplings include hooks 32 that grasp the light diffuser 8. In this embodiment, the light diffuser 8 is planar and the hooks 32 grasp a peripheral edge 34 of the light diffuser. A mounting point 14 retains the flash unit 6, and the flash unit is positioned to emit light toward the light diffuser.

When the assembly is used, the flash illuminates the light diffuser from behind and offers light quality similar to a more expensive soft box. A soft box is a photographic lighting device used to create even and diffused light by directing light through a box or cone-shaped apparatus with enclosed sides and some diffusing material on the face.

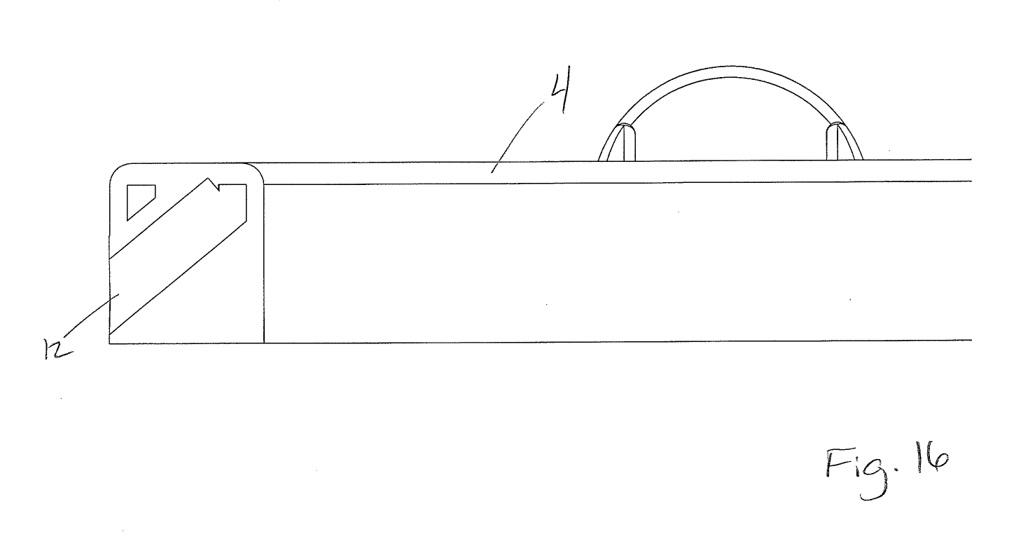

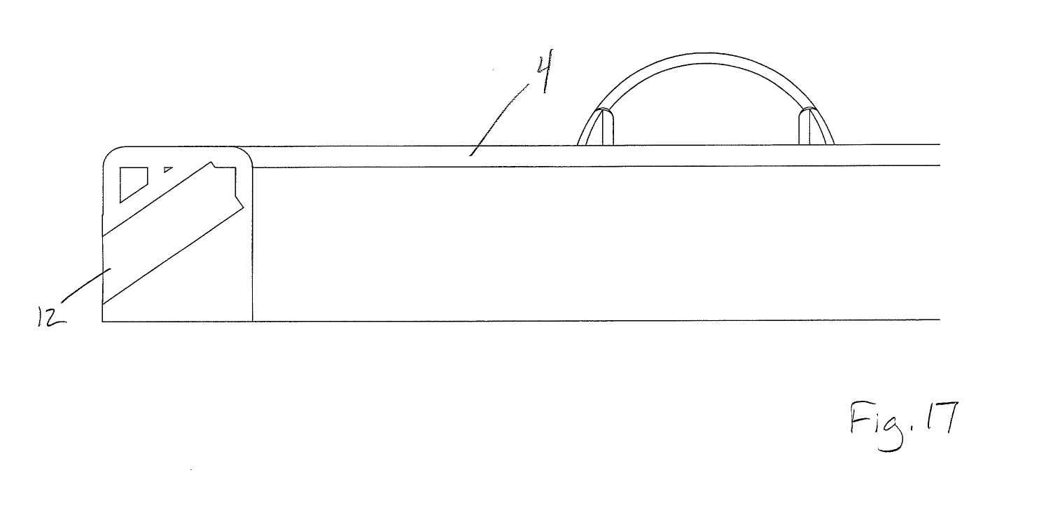

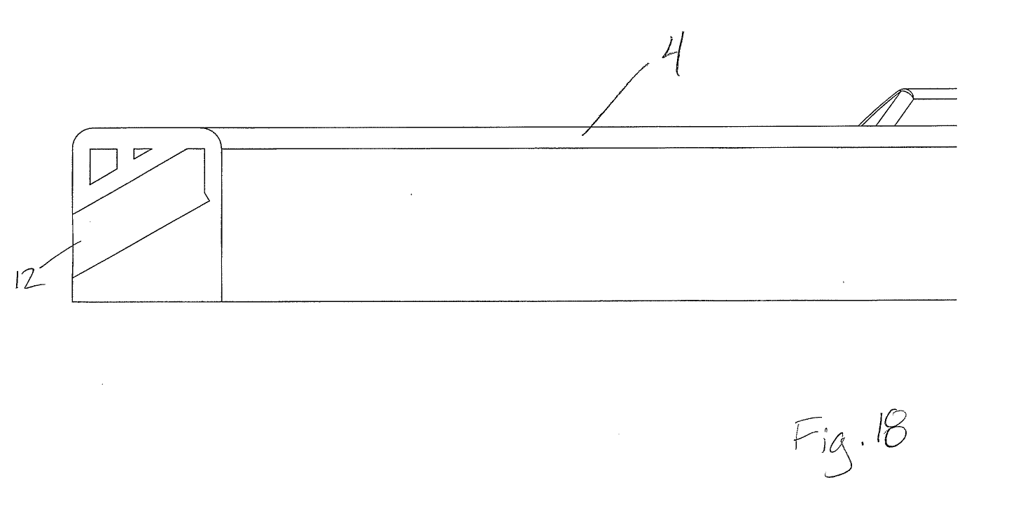

FIGS. 16-18 illustrate different cross-sections of the embodiment of the holder 4 that is illustrated in FIGS. 1-7. The holder includes different sets anchor points 12 including holes formed at different angles in the holder 4. In FIG. 16, a first set of anchor points are set at an angle of 40° from a plane through which light may pass from a flash unit through the frame of the holder and toward a light diffuser. The first ends of the rods may be inserted into the first set of anchor points to accommodate a light diffuser with a small sized width or diameter. In FIG. 17, a second set of anchor points are set at an angle of 35° from a plane through which light may pass from a flash unit through the frame of the holder and toward a light diffuser. The second ends of the rods may be inserted into the second set of anchor points to accommodate a light diffuser with a medium sized width or diameter. In FIG. 18, a third set of anchor points are set at an angle 30° from a plane through which light may pass from a flash unit through the frame of the holder and toward a light diffuser. The second ends of the rods may be inserted into the third set of anchor points to accommodate a light diffuser with a large sized width or diameter.

The holder may include one, two, three, four, or more sets of anchor points. Each separate set of anchor points may be fitted with rods to accommodate different sized light diffusers. When the holder includes more than one set of anchor points, the anchor points of the separate sets of anchor points may be set at different angles from each other. A set of anchor points may be set at range from 90° to 0°, 75° to 25°, 45° to 30°, etc., from a plane through which light may pass from a flash unit through the frame of the holder and toward a light diffuser.

The assembly may be held with one hand or mounted to a light stand, a monopod, an extension pole, etc., for easy mobility.

In an embodiment, the entire assembly can be assembled and disassembled quickly and easily with friction-fit connections. When disassembled, the assembly will fit neatly in a standard camera bag pocket.

The exemplary embodiments shown in the figures and described above illustrate but do not limit the subject matter disclosed in this specification. It should be understood that there is no intention to limit the subject matter in this specification to the specific form disclosed; rather, the disclosed subject matter is to cover all modifications and alternative constructions, as well as equivalents falling within the spirit and scope of the subject matter recited in the claims.

What is claimed is:

1. An adapter for joining a flash unit and a light diffuser, the adapter comprising:
a handle;
a holder attached to the handle, the holder including anchor points;
a mounting point attached to the handle, the mounting point being configured to retain a flash unit; and
rods including first ends and second ends, the first ends being configured to be attached to the anchor points, and the second ends including couplings configured to be attached to a light diffuser, wherein adapter is configured to position the flash unit to emit light toward the light diffuser.

2. The adapter according to claim 1, further comprising a bracket attached to the handle, wherein the mounting point is disposed on the bracket.

3. The adapter according to claim 1, wherein the holder further includes a frame including an opening, the anchor points are spaced apart on the frame, and the frame is oriented to allow the light emitted from the flash unit to pass through the opening and toward the light diffuser.

4. The adapter according to claim 3, wherein the frame includes a ring shape.

5. The adapter according to claim 1, wherein the rods are flexible.

6. The adapter according to claim 1, wherein each of the rods includes cylindrical sections, and adjacent ends of the cylindrical sections are configured to be detachably engaged together at a joint.

7. The adapter according to claim 1, wherein couplings include hooks configured to grasp the light diffuser.

8. The adapter according to claim 7, wherein the light diffuser is planar and the hooks grasp a peripheral edge of the light diffuser.

9. An adapter for joining a flash unit and a light diffuser, the adapter comprising:
a holder including anchor points;
rods including first ends and second ends, the first ends being configured to be attached to the anchor points, and the second ends including couplings configured to be attached to a light diffuser;
a mounting point attached to the holder, wherein the mounting point is configured to retain a flash unit in a position to emit light toward the light diffuser.

10. The adapter according to claim 9, wherein the holder further includes a frame including an opening, the anchor points are spaced apart on the frame, and the frame is oriented to allow the light emitted from the flash unit to pass through the opening and toward the light diffuser.

11. The adapter according to claim 10, wherein the frame includes a ring shape.

12. The adapter according to claim 9, wherein the rods are flexible.

13. The adapter according to claim 9, wherein each of the rods includes cylindrical sections, and adjacent ends of the cylindrical sections are configured to be detachably engaged together at a joint.

14. The adapter according to claim 9, wherein the couplings include hooks configured to grasp the light diffuser.

15. The adapter according to claim 14, wherein the light diffuser is planar and the hooks grasp a peripheral edge of the light diffuser.

16. An assembly comprising:
a light diffuser;
a flash unit; and
an adapter comprising:
a holder including anchor points,
rods including first ends and second ends, the first ends being attached to the anchor points and the second ends including couplings attached to the light diffuser,
a mounting point retaining the flash unit,
wherein the flash unit is positioned to emit light toward the light diffuser.

17. The assembly according to claim 16, wherein the holder further includes a frame including an opening, the anchor points are spaced apart on the frame, and the frame is oriented to allow the light emitted from the flash unit to pass through the opening and toward the light diffuser.

18. The assembly according to claim 17, wherein the frame includes a ring shape.

19. The assembly according to claim 16, wherein the couplings include hooks grasping the light diffuser.

20. The assembly according to claim 19, wherein the light diffuser is planar and the hooks grasp a peripheral edge of the light diffuser.
